(19) United States
(12) Patent Application Publication
(10) Pub. No.: US 2009/0278433 A1
(43) Pub. Date: Nov. 12, 2009

(54) Flat Discharge Lamp

(75) Inventors: Takehito Nakashima, Motosu-shi (JP); Makoto Noda, Motosu-shi (JP); Chiaki Ota, Kagoshima-ken (JP)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: LECIP CORPORATION, Gifu-ken (JP)

(21) Appl. No.: 12/091,037

(22) PCT Filed: Oct. 25, 2005
(86) PCT No.: PCT/JP2005/019575

§ 371 Date: Apr. 21, 2008

(51) Int. Cl. H01J 1/96

(52) U.S. Cl. 313/284

(57) ABSTRACT

A flat discharge lamp includes a projection formed on an outer surface of a case body. The projection forms a thick portion, which is relatively thick, in the case body. An intake-outtake port is formed in the thick portion so that it can receive a chip tube having an outer diameter of a size larger than or the same as a gap. The large chip tube can be coupled to a hermetic case without any limitations resulting from the gap of a discharge chamber (15). The large chip tube resists damaging and improves gas replacement efficiency in the discharge chamber without affecting discharge characteristics of the flat discharge lamp.

### FIELD OF THE INVENTION

The present invention relates to a flat discharge lamp.

### BACKGROUND ART

FIG. 8(a) shows a first example of a conventional flat discharge lamp. The flat discharge lamp 51 includes two glass substrates 52, which are opposed to each other with a gap therebetween. Each glass substrate 52 has an outer surface on which a transparent electrode 53 is formed and an inner surface on which a fluorescent material layer 54 is applied. The glass substrates 52 have peripheral portions that are bonded together with a glass adhesive 55. A hermetically sealed discharge chamber 56 is defined between the two glass substrates 52. Inert gas (discharge gas), such as argon or neon, is filled in the discharge chamber 56. When a driving voltage (a high-frequency alternating voltage) is applied between the transparent electrodes 53, a dielectric-barrier discharge occurs in the discharge chamber 56. Ultraviolet light associated with the discharge excites the fluorescent material 54 and emits light.

The replacement of gases in the discharge chamber 56 performed in manufacturing the flat discharge lamp 51 will now be described. A gas discharge opening 62, which is in communication with the discharge chamber 56, is formed between the edges of the glass substrates 52 in advance. A glass chip tube 61, which includes a large-diameter tube portion 61a and a small-diameter tube portion 61b, is prepared. The small-diameter tube portion 61b is inserted into the gas discharge opening 62 so that its distal end is arranged in the discharge chamber 56. The chip tube 61 is hermetically fixed to the gas discharge opening 62 with a glass adhesive 55. The chip tube 61 has an outer end 59 connected to a rubber intake-outtake pipe 63, which is coupled to a vacuum pump (not shown). The vacuum pump is driven to evacuate air from the discharge chamber 56 and create a vacuum state in the discharge chamber 56. An inert gas source (not shown), which is connected to the intake-outtake pipe 63, supplies inert gas, such as argon or neon, via the chip tube 61 to the discharge chamber 56 to replace gas in the discharge chamber 56. The small-diameter tube portion 61b of the chip tube 61 is burned and cut with a burner. The glass adhesive 55 and the glass material of the small-diameter tube portion 61b that are melted by the heat of the burner close the open end of the small-diameter tube portion 61b. This hermetically seals the inert gas-filled discharge chamber 56.

When evacuating air from the discharge chamber 56 and supplying discharge gas to the discharge chamber 56, the small-diameter tube portion 61b of the chip tube 61 is fixed to the glass substrates 52 (refer to FIG. 8(a)). The small-diameter tube portion 61b has an extremely small diameter that is so thin that it can be inserted into the gas discharge opening 62 to reach the discharge chamber 56. That is, the small-diameter tube portion 61b must have an outer diameter of a size smaller than the gap between the glass substrates 52. The small-diameter tube portion 61b, which is very thin, easily breaks when, for example, replacing gas in the discharge chamber 56 or when connecting the chip tube 61 and the intake-outtake pipe 63. If the chip tube 61 is broken, the replacement of gas in the discharge chamber 56 is interrupted. This lowers the efficiency of the gas replacement.

FIG. 8(b) shows a second example of a conventional flat discharge lamp that prevents the chip tube 61 from being broken (refer to patent publication 1). Two chip tubes, namely, an inner chip tube 71 and an outer chip tube 72, are used instead of the chip tube 61 shown in FIG. 8(a). The inner chip tube 71 has an outer diameter of a size smaller than the gap between glass substrates 52 so that the distal end of the inner chip tube 71 can reach a discharge chamber 56. The outer chip tube 72 includes a large-diameter tube portion 72a and a small-diameter tube portion 72b, which has a smaller diameter than the large-diameter tube portion 72a. The small-diameter tube portion 72b has an outer diameter of a size larger than the gap between the glass substrates 52. Thus, the small-diameter tube portion 72b cannot be inserted into the discharge chamber 56. To fill discharge gas in the discharge chamber 56, an inner end of the inner chip tube 71 is arranged in the discharge chamber 56, the small-diameter tube portion 72b of the outer chip tube 72 is arranged to surround the outer end of the inner chip tube 71, and the open end of the small-diameter tube portion 72b is hermetically fixed to the side surfaces of the glass substrates 52 with a glass adhesive 55.

Then, an intake-outtake pipe 63 is connected to the large-diameter tube portion 72a of the outer chip tube 72. A vacuum pump is driven to evacuate air from the discharge chamber 56 and create a vacuum state in the discharge chamber 56. An inert gas source, which is connected to the intake-outtake pipe 63, supplies inert gas to the discharge chamber 56 via the inner chip tube 71 and the outer chip tube 72. The small-diameter tube portion 72b of the outer chip tube 72 is burned and cut by a burner. The glass adhesive 55 and the glass material of the small-diameter tube portion 72b that are melted by the heat of the burner close the open end of the small-diameter tube portion 72b. This hermetically seals the inert gas-filled discharge chamber 56.

The double-tube structure of the inner chip tube 71 and the outer chip tube 72 reduces damage to the inner chip tube 71 and the outer chip tube 72. For example, stress applied to the outer chip tube 72 when the outer chip tube 72 and the intake-outtake pipe 63 are connected to each other is prevented from acting on the inner chip tube 71. The outer chip tube 72, which is larger than the inner chip tube 71, has a higher level of strength than the inner chip tube 71. Therefore, in comparison with the first prior art example shown in FIG. 8(a), damage to the inner chip tube 71 and the outer chip tube 72 are reduced when replacing gas in the discharge chamber 56 or when connecting the chip tube 61 and intake-outtake pipe 63.

### [Patent Publication 1] Japanese Laid-Open Patent Publication No. 2002-237258

### DISCLOSURE OF THE INVENTION

However, to arrange the inner chip tube 71 in the discharge chamber 56, the outer diameter of the inner chip tube 71 must have a size smaller than the gap between the glass substrates 52. The outer diameter of the inner chip tube 71 may be increased when the gap between the glass substrates 52 is increased. However, the gap between the glass substrates 52, which greatly affects the discharge characteristics of the flat discharge lamp 51, is required to be set in accordance with the discharge distance that is determined by required light emission performance of the flat discharge lamp 51. Accordingly, an increase in the gap between the glass substrates 52 to increase the outer diameter of the inner chip tube 71 would not be realistic. In this manner, the gap between the glass substrates 52 limits the outer diameter of the inner chip tube 71.

Due to an increase in the demand for the flat discharge lamp 51, it is required that the manufacturing efficiency of the flat discharge lamp 51 be improved. An increase in the gas replacement efficiency of the discharge chamber 56 would improve the manufacturing efficiency of the flat discharge lamp 51. The gas replacement efficiency of the discharge chamber 56 is greatly affected by the inner diameter of the inner chip tube 71. More specifically, a larger flow passage area of the inner chip tube 71 would smooth the flow of air and discharge gas in the inner chip tube 71. However, for the reasons described above, an increase in the outer diameter of the inner chip tube 71 is restricted. This interferes with further improvement of the gas replacement efficiency in the discharge chamber 56.

It is an object of the present invention to provide a flat discharge lamp that improves gas replacement efficiency in a discharge chamber without affecting the discharge characteristics of the flat discharge lamp.

To achieve the above object, one aspect of the present invention is a flat discharge lamp having a flat hermetic case including two dielectric plates opposed to each other with a gap therebetween and a side wall connecting peripheral portions of the two dielectric plates, with the hermetic case defining a hermetically sealed discharge chamber therein. A chip tube is coupled to the hermetic case and used to replace air and discharge gas in the discharge chamber, with the chip tube having an outer diameter of a size larger than or the same as the gap. At least one dielectric plate of the two dielectric plates includes a thick portion in the peripheral portion, with the thick portion being thicker than other parts of the dielectric plate. The side wall and the two dielectric plates define an intake-outtake port of a size sufficient to enable receipt of the chip tube, with the intake-outtake port being formed by using the thick portion.

In the above aspect, the at least one dielectric plate includes an outer surface on which is arranged a projection forming the thick portion.

In the above aspect, the dielectric plates each have an outer surface on which an electrode for causing a discharge in the discharge chamber is arranged. The two dielectric plates include a first dielectric plate having a light-emitting surface that emits light generated by the discharge and a second dielectric plate having an outer surface on which the projection is formed. The outer surface of the second dielectric plate is opposite to the light-emitting surface of the first dielectric flat plat.

In the above aspect, the flat discharge lamp further has a contour, a side surface that extends along the contour, and a chamfered portion formed in the side surface inward from the contour. The intake-outtake port opens in the chamfered portion. The chip tube has an outer end arranged in an area defined between the contour and the chamfered portion.

A further aspect of the present invention is a flat discharge lamp having a flat hermetic case including two dielectric plates opposed to each other with a gap therebetween and a side wall connecting peripheral portions of the two dielectric plates, with the hermetic case defining a hermetically sealed discharge chamber therein. Part of at least one dielectric plate of the two dielectric plates cooperates with part of the side wall to define an intake-outtake port of a size larger than or the same as the gap. A chip tube is coupled to the intake-outtake port and used to perform gas replacement in the discharge chamber. The chip tube has an outer diameter of a size greater than or the same as the gap.

In the above aspect, the chip tube has an inner end exposed in the discharge chamber, and the at least one dielectric plate has a step that comes in contact with the inner end of the chip tube.

In the above aspect, the at least one dielectric plate includes an outer surface on which is arranged a projection forming the thick portion, and the intake-outtake port is formed at a location corresponding to the projection.

It is preferable that the hermetic case includes a dielectric rib that extends linearly in one direction in the discharge chamber and supports the two dielectric plates, and the chip tube includes an axis that is parallel to the one direction in which the dielectric rib extends.

### BRIEF DESCRIPTION OF THE DRAWINGS

FIG. 1 is an exploded perspective view of a flat discharge lamp according to a first embodiment of the present invention;

FIG. 2 is a front view of the flat discharge lamp of FIG. 1;

FIG. 3 is a cross-sectional view of the flat discharge lamp taken along line 1-1 in FIG. 2;

FIG. 4 is a cross-sectional view of the flat discharge lamp taken along line 2-2 in FIG. 3;

FIG. 5 is an exploded perspective view of a flat discharge lamp according to a second embodiment of the present invention;

FIGS. 6(a), 6B, and 6C are respectively a plan view, a partial front view, and a partial bottom view of a case body shown in FIG. 5;

FIGS. 7(a) and 7B are partial front views showing modifications; and

FIGS. 8A and 8B are partial cross-sectional views of prior art flat discharge lamps.

### BEST MODE FOR CARRYING OUT THE INVENTION

A flat discharge lamp according to a first embodiment of the present invention will now be discussed. A flat discharge lamp 10 can be employed in a flat fluorescent lamp installed, for example, in the ceiling of a transportation vehicle.

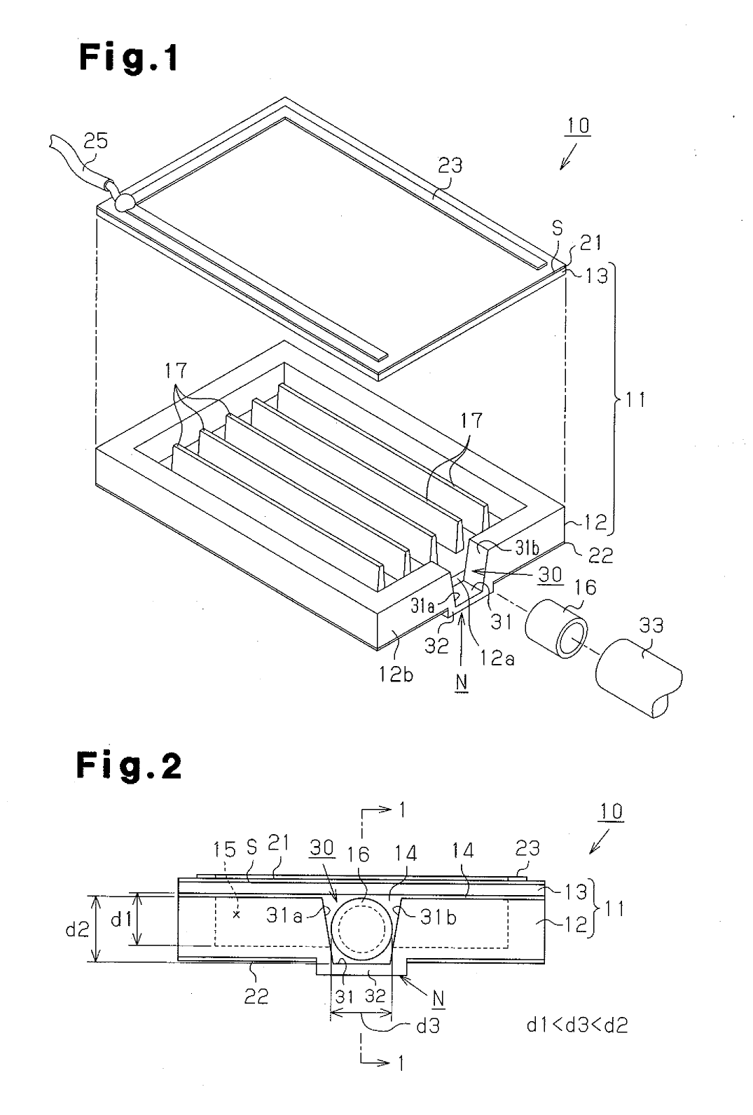

As shown in FIG. 1, the flat discharge lamp 10 includes a flat hermetic case 11. The hermetic case 11 includes a case body 12 and a lid 13. The case body 12 includes a bottom wall 12a and a side wall 12b, which extends along the periphery of the bottom wall 12a. The side wall 12b may be formed integrally with the bottom wall 12a. The case body 12 and the lid 13 are formed from a dielectric material, such as transparent glass. The lid 13 is fixed integrally to the case body 12 by a glass adhesive (glass frit having a low-melting point) 14. For example, in a state in which the periphery of the lid 13 is bonded to the side wall 12b of the case body 12 with the glass adhesive 14, the case body 12 and the lid 13 are sintered to integrate the lid 13 and the case body 12. The lid 13 functions as a first dielectric plater and the bottom wall 12a functions as a second dielectric plate.

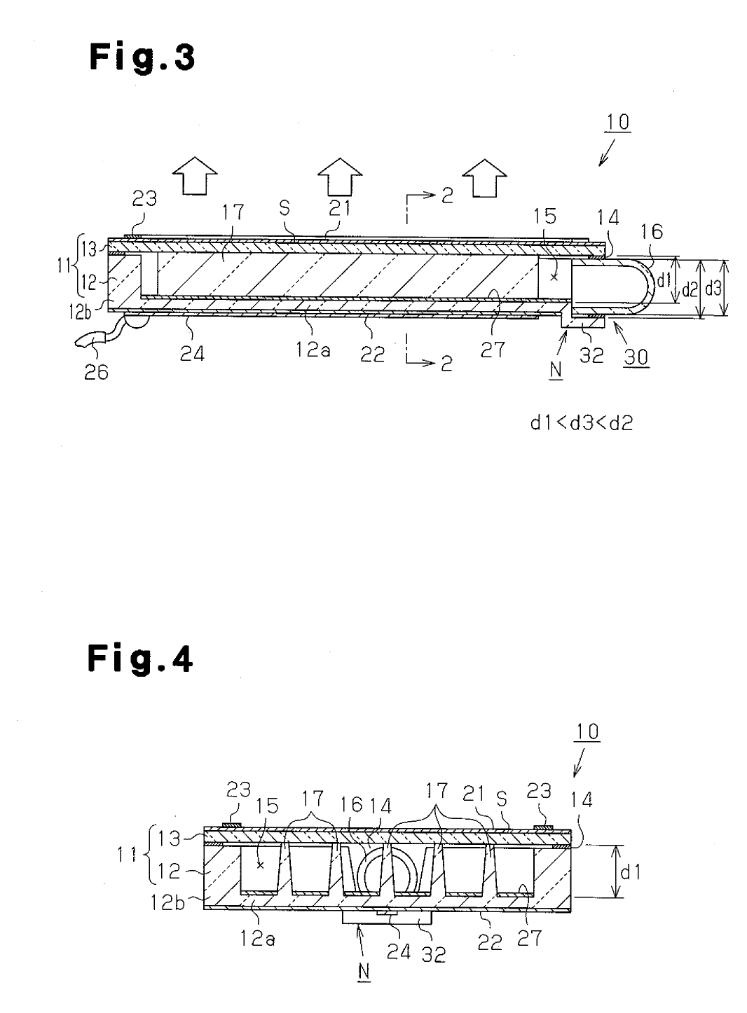

A discharge chamber will now be described. As shown in FIG. 3, the lid 13 has an inner surface that is parallel to the inner bottom surface (inner surface of the bottom wall 12a) of the case body 12 and spaced from the inner bottom surface of the case body 12 by a predetermined gap (discharge distance) d1. The case body 12, the lid 13, and the glass adhesive 14 define a discharge chamber 15, which is hermetically sealed. A chip tube 16, which has a sealed outer end, is attached to the side wall 12b so as to be communicable with the discharge chamber 15 (refer to FIG. 3). The chip tube 16 has an inner end arranged inward from the side wall 12b and an outer distal end arranged outward from the side wall 12b. The chip tube 16 is used to fill inert gas (discharge gas), such as xenon (Xe) or a mixture of Xe and other gas, into the discharge chamber 15. The gas pressure of the discharge gas in the discharge chamber 15 is lower than atmospheric pressure. A structure for coupling the chip tube 16 to the hermetic case 11 will be described in detail later.

Dielectric ribs will now be described. As shown in FIGS. 3 and 4, a plurality of (five in the first embodiment) dielectric ribs 17 are formed on the inner bottom surface of the case body 12 in the discharge chamber 15. Each of the dielectric ribs 17 is an elongated plate formed from a dielectric material such as transparent glass or the like. In the discharge chamber 15, the plurality of dielectric ribs 17 are arranged in parallel at a predetermined interval. In a state in which the lid 13 is fixed to the side wall 12a with the glass adhesive 14, each dielectric rib 17 has a distal end surface of which entire length comes into contact with the inner surface of the lid 13 so as to support the lid 13. This maintains a fixed gap between the inner bottom surface of the case body 12 and the inner surface of the lid 13. In the example shown in FIG. 4, each dielectric rib 17 is wedge-shaped and becomes thinner from its basal end toward its distal end. The distal end surface of each dielectric rib 17 has a smaller area than the basal end surface of the dielectric rib 17.

Transparent electrodes will now be described. As shown in FIG. 4, the lid 13 has an outer surface (top surface as viewed in FIG. 3) that functions as a light-emitting surface (surface from which light is emitted) S. A transparent electrode 21, which is a thin film, is arranged on the light-emitting surface S. A transparent electrode 22, which is a thin film, is formed opposite to the light-emitting surface S on an outer surface of the bottom wall 12a (lower surface as viewed in FIG. 3). The transparent electrodes 21 and 22 are formed from, for example, indium tin oxide (ITO).

A conductor 23 is formed on an outer surface of the transparent electrode 21, and a conductor 24 is formed on an outer surface of the transparent electrode 22. The conductors 23 and 24 are formed on the outer surfaces of the transparent electrodes 21 and 22 by applying and sintering, for example, silver paste. The conductor 23 is formed on the edges of the transparent electrode 21 so as to extend along three sides of the transparent electrodes 21. The conductor 24 is formed in the middle of the transparent electrode 22 and extends linearly parallel to the longitudinal direction of the dielectric ribs 17. The conductor 24 has two ends respectively facing two opposing sides of the transparent electrode 22. The conductors 23 and 24 are electrically connected to an AC power supply or a drive circuit (not shown) via lead wires 25 and 26. In the first embodiment, the lead wires 25 and 26 are electrically coupled to the conductors 23 and 24. In the preferred embodiment, the lead wire 25 is soldered to one corner of the conductor 23, and the lead wire 26 is soldered to one end of the conductor 24. In the discharge chamber 15, a fluorescent material layer 27 is formed on the inner bottom surface of the case body 12. The fluorescent material layer 27 is, for example, a layer containing fluorescent materials respectively corresponding to the three colors of red, green, and blue.

The emission of light from the flat discharge lamp 10 will now be described. When a driving voltage (e.g., 1 to 3 kV) is applied between the transparent electrodes 21 and 22 via the conductors 23 and 24, an electric discharge (dielectric-barrier discharge) occurs in the discharge chamber 15. The discharge generates ultraviolet light. The ultraviolet light is converted to visible light by the fluorescent material layer 27. The visible light, which serves as illumination light, is emitted from the light-emitting surface S of the flat discharge lamp 10. When the fluorescent material layer 27 contains fluorescent materials respectively corresponding to the three colors of red, green, and blue, white illumination light is emitted.

Each dielectric rib 17 has a wedge shape that is thinner in the direction of the light-emitting surface S. This enables the light-emitting surface S of the lid 13 to have a sufficiently large effective illumination area. In this case, the flat discharge lamp 10 has an optimum illumination state. The dielectric ribs 17 support the bottom wall 12a of the case body 12 and the lid 13. In this case, the hermetic case 11 has a high rigidity. This structure reduces deformation of the case body 12 (inward deformation of the bottom wall 12a and the lid 13) caused by a difference between the gas pressure of the discharge chamber 15 and the atmospheric pressure, and maintains a fixed distance between the transparent electrodes 21 and 22. As a result, the flat discharge lamp 10 has a stable electric discharge.

An intake-outtake port will now be described. The structure for coupling the chip tube 16 to the hermetic case 11 will be described in detail. As shown in FIGS. 1 and 2, the case body 12 and the lid 13 define an intake-outtake port 30. The chip tube 16 is fixed in the intake-outtake port 30. The case body 12 has an accommodation recess 31. The accommodation recess 31 is formed in the middle of a side wall 12b extending perpendicular to the longitudinal direction of the dielectric ribs 17. The intake-outtake port 30 is defined by the accommodation recess 31 and the lid 13, which covers the opening of the accommodation recess 31.

The accommodation recess 31 will now be described in detail. The bottom surface (outer surface of the bottom wall 12a) of the case body 12 has a projection 32 located in the middle of a side that extends perpendicular to the longitudinal direction of the dielectric ribs 17. In other words, the bottom wall 12a has a thick portion N in the middle of the side extending perpendicular to the longitudinal direction of the dielectric ribs 17. The thick portion N is thicker than other parts of the bottom wall 12a. The thick portion N is formed on a peripheral portion of the bottom wall 12a in correspondence with the side wall 12b. One example of the projection 32 is a flat rectangular projection. The accommodation recess 31 is formed in the thick portion N of the bottom wall 12a.

As shown in FIG. 3, the accommodation recess 31 has a depth d2, which is the distance between the inner bottom surface of the accommodation recess 31 and the open end surface of the case body 12 (end surface of the side wall 12b at the side of the lid 13). The depth d2 is greater than the gap d1 between the inner bottom surface (inner surface of the bottom wall 12a) of the case body 12 and the inner surface of the lid 13. The accommodation recess 31 is formed by taking use of the thick portion N (projection 32) so that the depth d2 of the accommodation recess 31 becomes greater than the gap d1.

The intake-outtake port 30 receives the chip tube 16, which has an outer diameter d3 of a size larger than or the same as the gap d1 between the bottom wall 12a and the lid 13. The chip tube 16 is usable if the outer diameter d3 has a size larger than the gap d1 and smaller than the depth d2 of the accommodation recess 31 (d1<d3<d2).

As shown in FIGS. 1 and 2, the side wall 12b has inclined surfaces 31a and 31b, which define the accommodation recess 31 and gradually become closer to each other toward the bottom wall 12a. The chip tube 16 is inserted from the outer side and fixed with the glass adhesive 14 to the accommodation recess 31 (intake-outtake port 30). The axis of the fixed chip tube 16 is parallel to the longitudinal direction of the dielectric ribs 17. As shown in FIG. 3, a step 31c, which comes in contact with the inner end of the chip tube 16, may be formed on the bottom wall 12a. Contact with the step 31c may be such that it determines the insertion depth of the chip tube 16. The step 31c may be formed to be orthogonal or inclined to the bottom wall 12a.

Enclosure of the discharge gas will now be described. When manufacturing the flat discharge lamp 10, a process of replacing the air in the discharge chamber 15 with discharge gas is performed. In the gas replacement process, the chip tube 16, to which the glass adhesive 14 has been applied, is inserted into the intake-outtake port 30 from the outer side. Then, the chip tube 16 and the hermetic case 11 are sintered to hermetically fix the chip tube 16 to the intake-outtake port 30. An intake-outtake pipe 33 (refer to FIG. 1), which is connected to a vacuum pump (not shown), is connected to the outer end of the chip tube 16. Then, the vacuum pump (not shown) is driven to evacuate air from the discharge chamber 15 and create a vacuum state in the discharge chamber 15. Next, the intake-outtake pipe 33 is connected to an inert gas source (not shown) to supply inert gas (discharge gas) to the discharge chamber 15 through the chip tube 16. Then, a middle part of the chip tube 16 is burned and cut by a burner. The heat of the burner melts the glass adhesive 14 and the glass material of the chip tube 16 and closes the opening of the chip tube 16. This hermetically seals the discharge chamber 15, in which the inert gas is filled (refer to FIG. 3).

The gas replacement efficiency of the discharge chamber 15 is greatly affected by the inner diameter of the chip tube 16. More specifically, a larger inner diameter of the chip tube 16 would increase the flow passage area and smooth the flow of air and discharge gas. In the first embodiment, the outer diameter d3 of the chip tube 16 has a size larger than the gap d1 between the inner bottom surface of the case body 12 and the inner surface of the lid 13. This improves the gas replacement efficiency of the discharge chamber 15 and improves the manufacturing efficiency of the flat discharge lamp 10 as compared with the prior art (refer to FIG. 8) in which the outer diameter d3 of the chip tube 16 is small enough to enable insertion into the discharge chamber 15.

The chip tube 16 is received in and fixed to the intake-outtake port 30. The chip tube 16 is supported by the case body 12 (more precisely, the accommodation recess 31) and the lid 13. This ensures that the chip tube 16 has sufficient supporting strength. The chip tube 16 may be fixed, for example, in a state in which it abuts against the side surface of the hermetic case 11 (outer surface of the side wall 12b). In this case, however, the chip tube 16 would only be supported by the glass adhesive 14 between the chip tube 16 and the side surface of the hermetic case 11. Thus, the supporting strength of the chip tube 16 may become insufficient.

The first embodiment has the advantages described below.

(1) The projection 32 is arranged on the bottom surface (outer surface of the bottom wall 12a) of the case body 12 at a location corresponding to the side wall 12b of the case body 12. This forms the thick portion N of the side wall 12b, which is thicker than other parts of the side wall 12b of the case body 12. The thick portion N is used to form the intake-outtake port 30 that enables insertion of the chip tube 16, the outer diameter d3 of which size is larger than or the same as the gap d1 between the inner bottom surface of the case body 12 and the lid 13. This allows the outer diameter d3, and thus the inner diameter, of the chip tube 16 to be increased as compared with when the chip tube is insertable between the inner bottom surface of the case body 12 and the lid 13. Accordingly, the gas replacement efficiency of the discharge chamber 15 is improved, and the manufacturing efficiency of the flat discharge lamp 10 is consequently improved. Further, the chip tube 16 can be enlarged as compared with the prior art. Thus, the strength of the chip tube 16 is improved. Accordingly, the chip tube 16 resists breakage and damages when the intake-outtake pipe 33 is connected to the outer end of the chip tube 16 when the flat discharge lamp 10 is manufactured.

(2) The intake-outtake port 30 is formed so that it can receive the chip tube 16, the outer diameter d3 of which size is larger than or the same as the gap (discharge distance) d1. Thus, the gap d1 between the inner bottom surface of the case body 12 and the lid 13 does not have to be increased in accordance with the outer diameter of the gap d1, and conversely, the outer diameter of the chip tube 16 does not have to be decreased in accordance with the gap d1. Further, the coupling of the chip tube 16 is enabled regardless of the gap d1. This improves the gas replacement efficiency of the discharge chamber 15 without affecting discharge characteristics of the flat discharge lamp 10.

(3) The projection 32 formed on the bottom surface (outer surface of the bottom wall 12a) of the case body 12 forms the thick portion N on the bottom wall 12a. The thick portion N of the bottom wall 12a is thicker than other parts of the bottom wall 12a. Thus, the thick portion N is formed easily without complicating the structure of the hermetic case 11.

(4) The projection 32 is formed on the bottom surface (outer surface of the bottom wall 12a) of the case body 12 opposite to the lid 13, which provides the light-emitting surface S. This improves the appearance of the flat discharge lamp 10 compared to when the projection 32 is formed on the lid 13 (e.g., near the light-emitting surface S). Further, when the flat discharge lamp 10 is used as a ceiling light of a transportation vehicle, the flat discharge lamp 10 is often arranged so that the light-emitting surface S faces the interior of the vehicle. In such a case, it is preferable that the projection 32 be arranged on the bottom surface of the case body 12 (outer surface of the bottom wall 12a) opposite to the light-emitting surface S.

(5) Only one chip tube 16 coupled to the intake-outtake port 30. Thus, the number of components is less as compared with the double-tube structure chip tube of the prior art that includes the inner chip tube and the outer chip tube.

The coupling of the prior art chip tube with the double-chip structure in the intake-outtake port requires the task of fixing an inner chip tube and outer chip tube to a hermetic case. In contrast, the chip tube 16 of the first embodiment is fixed to the intake-outtake port 30 simply by inserting the chip tube 16 into the intake-outtake port 30. This reduces the task required to fix the chip tube 16 to the intake-outtake port 30 and improves the productivity of the flat discharge Tamp 10.

(6) The chip tube 16 is fixed in a state in which it is inserted from the outer side. The chip tube 16 is supported not only by the glass adhesive 14 but also by the inner surface of the intake-outtake port 30. This improves the supporting strength of the chip tube 16 as compared with the prior art in which the chip tube is fixed with glass adhesive in a state in which it is abut against the side surface of the case body.

(7) The axis of the chip tube 16 is parallel to the longitudinal direction of the dielectric ribs 17. The chip tube 16 is arranged so that the longitudinal direction of the dielectric ribs 17 coincides with intake and outtake direction of the chip tube 16. This structure prevents the dielectric ribs 17 from blocking the flow of air and discharge gas in the discharge chamber 15 unlike when the axis of the chip tube 16 extends perpendicularly to or intersects with the longitudinal direction of the dielectric ribs 17. Moreover, the dielectric ribs 17 smoothly guide the flow of gas toward the chip tube 16. As a result, the gas replacement efficiency of the discharge chamber 15 is improved.

(8) The accommodation recess 31 formed in the side wall 12b of the case body 12 and the lid 13 defines the intake-outtake port 30. This structure facilitates the formation of the accommodation recess 31 as compared with when, for example, the peripheral portions of two dielectric plates are bonded together with the glass adhesive 14 so as to leave an intake-outtake port.

(9) The accommodation recess 31 has inner surfaces defined by the inclined surfaces 31a and 31b, which are formed to become closer to each other toward the lid 13. Thus, the chip tube 16 is stably supported at the bottom portion of the accommodation recess 31.

A flat discharge lamp 10 according to a second embodiment of the present invention will now be described with reference to FIGS. 6(a) to 6C. The second embodiment differs from the first embodiment in the location of the intake-outtake port in the hermetic case 11. Components that are the same as those in the first embodiment are denoted by the same reference numerals and will not be described in detail.

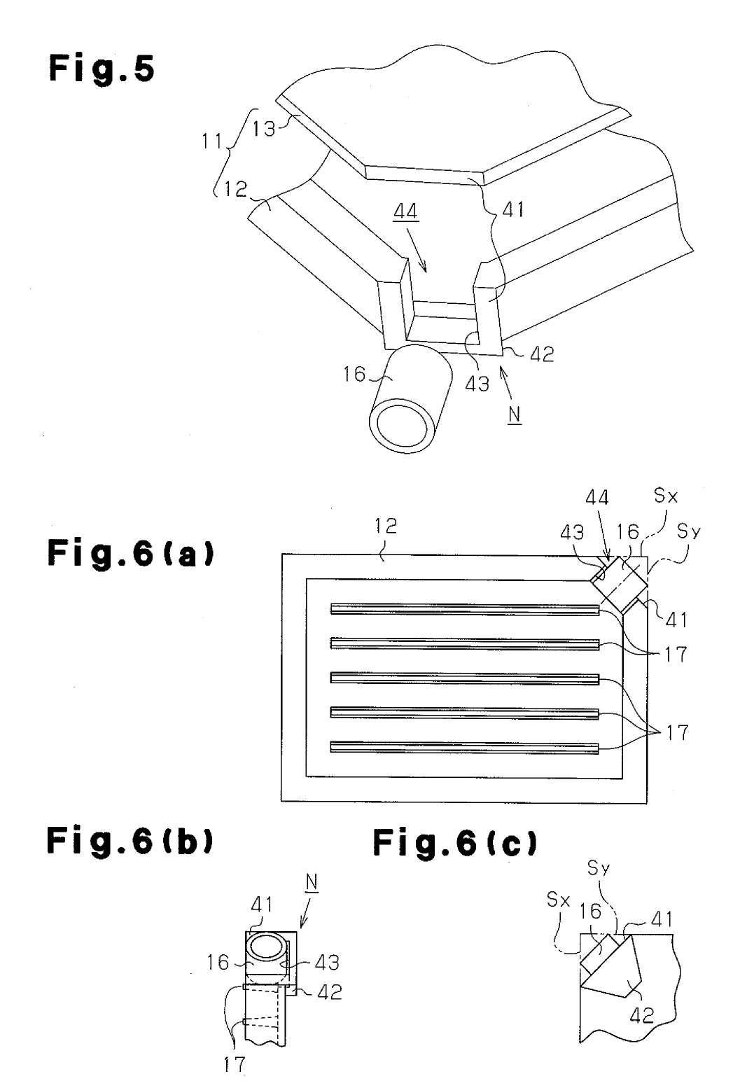

As shown in FIGS. 5 and 6(a), the hermetic case 11 (a case body 12 and a lid 13) includes a chamfered portion 41, which is formed in one of the four corners of the hermetic case 11. The chamfered portion 41 forms part of the side wall 12b. The chamfered portion 41 intersects with a diagonal line of the case body 12 (more precisely, the bottom wall 12a).

As shown in FIGS. 6(b) and 6(c), the bottom surface of the case body 12 (outer surface of the bottom wall 12a) has a projection 42, which is formed on the corner corresponding to the chamfered portion 41. One example of the projection 42 is a flat trapezoidal projection (refer to FIG. 6(c)). The corner in the bottom wall 12a of the case body 12 that includes the projection 42 is thicker than other parts of the bottom wall 12a.

As shown in FIG. 5, an accommodation recess 43 is formed in the chamfered portion 41 of the case body 12. The accommodation recess 43 has a depth d2, which is the distance between the open end surface of the case body 12 and the inner bottom surface of the accommodation recess 43. The depth d2 is greater than the gap d1 between the inner bottom surface of the case body 12 and the inner surface of the lid 13. The accommodation recess 43 and the lid 13 define an intake-outtake port 44. The intake-outtake port 44 can receive the chip tube 16, the outer diameter d3 of which size is larger than the gap d1.

As shown in FIG. 6(a), the side wall 12b has two side surfaces adjacent to the chamfered portion 41. Two hypothetical planes Sx and Sy (indicated by double-dashed lines), which extend from the two side surfaces, and the chamfered portion 41 define a triangular area (triangular space). The chip tube 16 is fixed so that its outer end is arranged within the triangular area. That is, so that its outer end does not hang out from the contour (Sx and Sy) of the flat discharge lamp 10.

The second embodiment has the same advantages as advantages (1) to (6) and (8) of the first embodiment. Further, damage to the chip tube 16 that may occur when the flat discharge lamp 10 is transported is reduced. For example, even when the side surfaces of the hermetic case 11 come in contact with an object, such as a wall, the chip tube 16 does not come in contact with the object since the outer end of the chip tube 16 does not hang out from the hypothetical planes Sx and Sy of the hermetic case 11. This reduces damage to the chip tube 16.

The above embodiments may be modified as described below.

In the first embodiment, the intake-outtake port 30 is arranged in the middle of the side wall 12b of the hermetic case 11. However, the intake-outtake port 30 may be arranged anywhere on the side wall 12b. This also obtains advantages (1) to (9) of the first embodiment.

In the first and second embodiments, the flat discharge lamp 10 is quadrangle. However, the flat discharge lamp 10 does not have to be shaped to be quadrangle. The flat discharge lamp 10 may be polygonal, such as triangular or pentagonal, circular, elliptical, or be shaped by a combination of such shapes. For example, when the flat discharge lamp 10 is circular, the chamfered portion 41 of the second embodiment may be formed so that the outer end of the chip tube 16 is accommodated in an area defined by the circular contour of the fiat discharge lamp 10 and the chamfered portion 41.

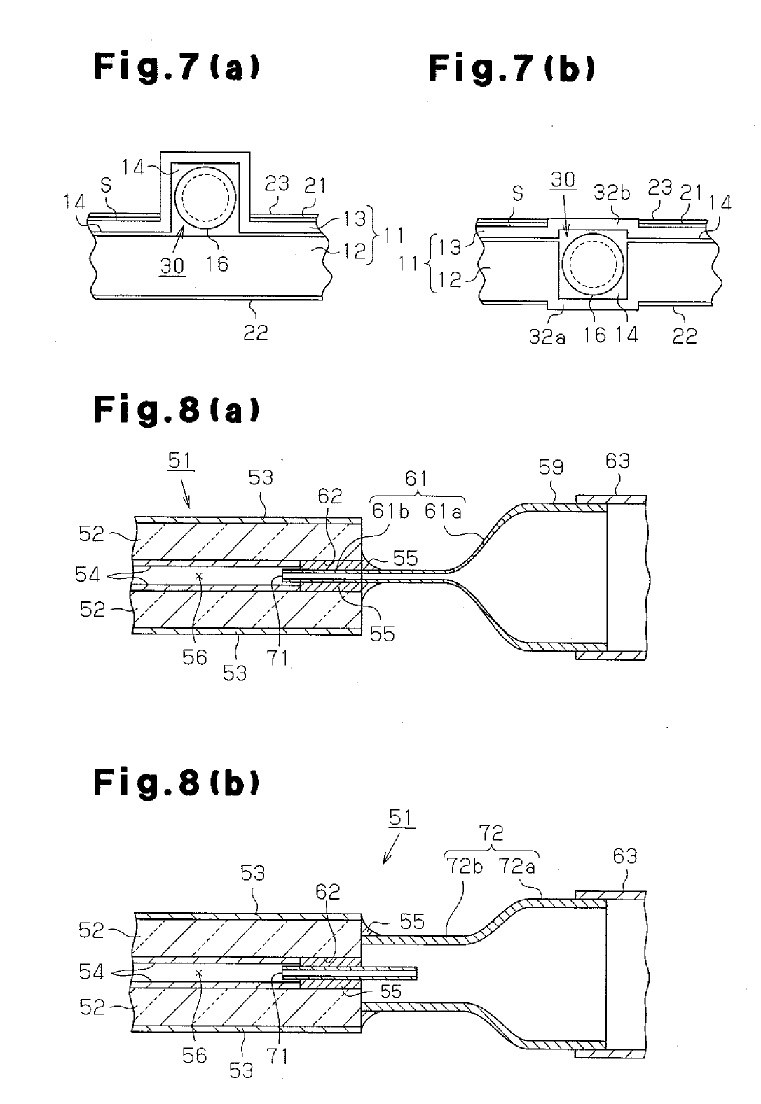

In the first embodiment, the projection 32 is formed on the bottom surface (outer surface of the bottom wall 12a) of the case body 12. However, as shown in FIG. 7(a), the projection 32 may be formed on the surface (that is, the light-emitting surface S) of the lid 13, and the projection 32 may be used to form the intake-outtake port 30 (accommodation recess 31). This would also obtain advantages (1) to (3) and (5) to (8) of the first embodiment.

As shown in FIG. 7(b), the bottom surface of the case body 12 and the surface of the lid 13 may respectively include projections 32a and 32b, and the projections 32a and 32b may be used to form the intake-outtake port 30 (accommodation recess 31). In this case, the projection heights of the projections 32a and 32b from the bottom surface of the case body 12 and from the surface of the lid 13 become lower than the projection height of the projection 32 from the bottom surface of the case body 12 in the first embodiment. This minimizes the projection height of the projections 32a and 32b from the bottom surface of the case body 12 and the surface of the lid 13.

In the first and second embodiments, the flat discharge lamp 10 is used as an illumination lamp that emits visible light generated by the fluorescent material layer 27, which is irradiated with vacuum ultraviolet light generated during xenon discharge. However, the fluorescent material layer may be eliminated. In this case, the flat discharge lamp 10 is used as an ultraviolet lamp that emits vacuum ultraviolet light generated during xenon discharge.

In the second embodiment, the dielectric ribs 17 may be arranged so that the longitudinal direction of the dielectric ribs 17 coincides with the axial direction of the chip tube 16. This obtains advantage (7) of the first embodiment.

In the first and second embodiments, the outer diameter d3 of the chip tube 16 has a size larger than the gap d1. However, the outer diameter d3 may have a size that is the same as the gap d1. This would also obtain the same advantages as the first embodiment.

In the first and second embodiments, the number of the intake-outtake ports 30 and 44 is not limited to one and may be a plural number. In the second embodiment, it would be preferable that a plurality of such intake-outtake ports 44 be arranged in the corners of the hermetic case 11.

In the first and second embodiments, the hermetic case 11 includes the case body 12 and the lid 13. The case body 12 includes the bottom wall 12a and the side wall 12b that are formed integrally. However, the bottom wall 12a and the side wall 12b of the case body 12 do not have to be formed integrally and may be formed separately. For example, the hermetic case 11 may be formed by sealing the peripheries of two dielectric plates (glass substrates), which are opposed to each other with a gap therebetween, with a glass adhesive. In this case, the opposing surfaces of the two glass substrates and the glass adhesive define a discharge chamber.

In the first and second embodiments, the flat discharge lamp 10 is used as a flat fluorescent lamp for a ceiling lamp of a transportation vehicle. However, the flat discharge lamp 10 may also be used, for example, as a backlight of a liquid crystal device or a household illumination lamp.

1. A flat discharge lamp comprising:
a flat hermetic case including two dielectric plates opposed to each other with a gap therebetween and a side wall connecting peripheral portions of the two dielectric plates, with the hermetic case defining a hermetically sealed discharge chamber therein; and
a chip tube coupled to the hermetic case and used to replace air and discharge gas in the discharge chamber, with the chip tube having an outer diameter of a size larger than or the same as the gap;
wherein at least one dielectric plate of the two dielectric plates includes a thick portion in the peripheral portion, with the thick portion being thicker than other parts of said dielectric plate; and
the side wall and the two dielectric plates define an intake-outtake port of a size sufficient to enable receipt of the chip tube, with the intake-outtake port being formed by using the thick portion.

2. The flat discharge lamp according to claim 1, wherein the at least one dielectric plate includes an outer surface on which is arranged a projection forming the thick portion.

3. The flat discharge lamp according to claim 2, wherein:
the dielectric plates each have an outer surface on which an electrode for causing a discharge in the discharge chamber is arranged; and
the two dielectric plates include a first dielectric plate having a light-emitting surface that emits light generated by the discharge and a second dielectric plate having an outer surface on which the projection is formed, with the outer surface of the second dielectric plate being opposite to the light-emitting surface of the first dielectric flat plat.

4. The flat discharge lamp according to claim 2, further comprising:
a contour, a side surface that extends along the contour, and a chamfered portion formed in the side surface inward from the contour;
wherein the intake-outtake port opens in the chamfered portion; and
the chip tube has an outer end arranged in an area defined between the contour and the chamfered portion.

5. A flat discharge lamp, comprising:
a flat hermetic case including two dielectric plates opposed to each other with a gap therebetween and a side wall connecting peripheral portions of the two dielectric plates, with the hermetic case defining a hermetically sealed discharge chamber therein, wherein part of at least one dielectric plate of the two dielectric plates cooperates with part of the side wall to define an intake-outtake port of a size larger than or the same as the gap; and
a chip tube coupled to the intake-outtake port and used to perform gas replacement in the discharge chamber, the chip tube having an outer diameter of a size greater than or the same as the gap.

6. The flat discharge lamp according to claim 5, wherein the chip tube has an inner end exposed in the discharge chamber, and the at least one dielectric plate has a step that comes in contact with the inner end of the chip tube.

7. The flat discharge lamp according to claim 6, wherein the at least one dielectric plate includes an outer surface on which is arranged a projection forming the thick portion, and the intake-outtake port is formed at a location corresponding to the projection.

8. The flat discharge lamp according to claim 1, wherein:
the hermetic case includes a dielectric rib that extends linearly in one direction in the discharge chamber and supports the two dielectric plates; and
the chip tube includes an axis that is parallel to the one direction in which the dielectric rib extends.

9. The flat discharge lamp according to claim 5, wherein:
the hermetic case includes a dielectric rib that extends linearly in one direction in the discharge chamber and supports the two dielectric plates; and
the chip tube includes an axis that is parallel to the one direction in which the dielectric rib extends.
